(19) United States
(12) Patent Application Publication
(10) Pub. No.: US 2007/0159078 A1
(43) Pub. Date: Jul. 12, 2007

(54) Organic light emitting diode display with improved heat dissipation

(75) Inventors: Kyong-Tae Park, Uijeongbu-si (KR); Byung-Sik Koh, Gwangmyeong-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/643,086

(22) Filed: Dec. 20, 2006

(30) Foreign Application Priority Data
Dec. 26, 2005 (KR) 10-2005-0129418

(51) Int. Cl. H01J 61/52; H01K 1/58; H01J 1/62

(52) U.S. Cl. 313/504; 313/506; 313/11; 313/33; 313/512

(57) ABSTRACT

An organic light emitting diode (OLED) display that dissipates heat with an improved efficiency is presented. The OLED display includes an OLED panel that displays an image, a heat sink that is attached the OLED panel, and a heat transfer pad that is positioned between the heat sink and the OLED panel, wherein the heat transfer pad is shaped to cover a position of the heat generating unit of the OLED panel.

### CROSS-REFERENCE TO RELATED APPLICATION

This application claims priority to and the benefit of Korean Patent Application No. 10-2005-0129418 filed in the Korean Intellectual Property Office on Dec. 26, 2005, the entire content of which is incorporated herein by reference.

### BACKGROUND OF THE INVENTION

(a) Field of the Invention

The present invention relates to an organic light emitting diode display.

(b) Description of the Related Art

Recently, demand for light and compact displays for monitors, televisions, and such has increased, and cathode ray tubes (CRTs) have been increasingly replaced with liquid crystal displays (LCDs) as a result of such demand.

However, although LCDs have numerous advantages over traditional mainstream displays such as CRTs, LCDs have their own set of shortcomings. For example, an LCD requires a separate backlight as a light-emitting device, and has many problems in response speed, viewing angle, and so on.

An organic light emitting diode display (OLED display) has recently been receiving much attention as a display device that can overcome the shortcomings of LCDs.

An OLED display includes two electrodes and an emission layer that is positioned therebetween. Excitons form when electrons from one electrode and holes from the other electrode combine in the emission layer, and the excitons emit light upon transitioning to a ground state.

Because the OLED display is a self luminescent display that does not require a separate light source, it is advantageous from the perspective of power consumption. Moreover, it has fast response speed, wide viewing angle, and a good contrast ratio.

Since an OLED display is a self luminescent type display, it generates heat. As the OLED display is increased in size, dissipating the generated heat effectively becomes more important. In a large OLED display, it is more common for the peripheral units to overheat than for the image display unit to overheat. This is because much heat is generated by the power supply component of the peripheral unit.

A heat transfer pad is attached entirely between the OLED display and a heat sink in order to help heat dissipation. While the heat transfer pad helps heat dissipation, it is neither the most efficient solution nor the most cost-effective solution because an expensive heat transfer pad is also attached to image display units that do not overheat.

### SUMMARY OF THE INVENTION

The present invention has been made in an effort to provide an OLED display that can be made more cost-effectively than the conventional OLED displays and that is capable of dissipating heat with improved efficiency.

An exemplary embodiment of the present invention provides an OLED display including an OLED panel that displays an image, a heat sink that is attached to the OLED panel, and a heat transfer pad that is positioned between the heat sink and the OLED panel. The OLED panel has a heat generating unit. The heat transfer pad is shaped to cover a position of the heat generating unit.

The OLED panel may include an image display unit for displaying an image and a peripheral unit adjacent to the display unit, and the heat generating unit of the OLED panel may be positioned in the peripheral unit.

The OLED panel may have a rectangular shape. In this case, the heat transfer pad may be shaped to cover at least one side of the rectangular OLED panel. A groove may be formed along at least one side of the heat sink. The heat transfer pad may be shaped to cover two parallel sides of the OLED panel. In this case, a groove may be formed along two parallel sides of the heat sink as well.

The heat transfer pad may be bar-shaped.

The heat transfer pad may be shaped like a frame that substantially matches the outline of the OLED panel.

The heat transfer pad may be inserted into the groove of the heat sink.

Portions of the heat sink around the groove may contact the OLED panel.

A power supply unit of the OLED panel may be formed in a peripheral unit of the OLED panel.

The heat transfer pad may be positioned to correspond to the power supply unit of the OLED panel.

The heat transfer pad may be made of a material having high thermal conductivity, such as graphite.

In another aspect, the present invention provides an OLED panel, a heat sink that is attached to the OLED panel, and a heat transfer pad that is positioned between the heat sink and the OLED panel. The OLED panel includes an image display unit for displaying an image and a peripheral unit that is adjacent to the display unit. A power supply unit of the OLED panel is formed in the peripheral unit of the OLED panel, and the heat transfer pad is positioned to correspond to the power supply unit of the OLED panel.

In yet another aspect, the present invention provides an OLED display including an OLED panel that displays an image, a heat sink that is attached to the OLED panel, and a heat transfer pad that is positioned between the heat sink and the OLED panel, wherein the heat transfer pad extends into a groove in the heat sink.

In yet another aspect, of the present invention provides an OLED display including an OLED panel that displays an image, a heat sink that is attached to the OLED panel, and a heat transfer pad that is positioned between the heat sink and the OLED panel, wherein a groove is formed in a peripheral unit of the heat sink and the heat transfer pad is inserted into the groove.

In yet another aspect, the present invention provides an OLED display including an OLED panel that displays an image, a heat sink that is attached to the OLED panel, and a heat transfer pad that is positioned between the heat sink and the OLED panel, wherein a part of the heat sink contacts the OLED panel.

The part of the heat sink coming in contact with the OLED panel may be a central part of the heat sink.

### BRIEF DESCRIPTION OF THE DRAWINGS

FIG. 1 is an equivalent circuit diagram of an OLED display according to an exemplary embodiment of the present invention.

FIG. 2 is a top plan view of an OLED display according to an exemplary embodiment of the present invention.

FIG. 3 is a cross-sectional view of the OLED display taken along the line II-II of FIG. 2.

FIG. 4 is a layout view of one pixel of an OLED panel of the OLED display according to an exemplary embodiment of the present invention.

FIGS. 5 and 6 are cross-sectional views of the OLED display taken along the lines V-V and VI-VI of FIG. 4, respectively.

FIG. 7 is a top plan view of an OLED display according to another exemplary embodiment of the present invention.

FIG. 8 is a cross-sectional view of the OLED display taken along the line VIII-VIII of FIG. 7.

FIG. 9 is a top plan view of an OLED display according to another exemplary embodiment of the present invention.

FIG. 10 is a cross-sectional view of the OLED display taken along the line X-X of FIG. 9.

### DETAILED DESCRIPTION OF THE EMBODIMENTS

The present invention will now be described more fully hereinafter with reference to the accompanying drawings, in which preferred embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element or “connected to” another element, it can be directly on or connected to the other element or intervening elements may also be present. In contrast, when an element is referred to as being “directly connected to” another element, there are no intervening elements present.

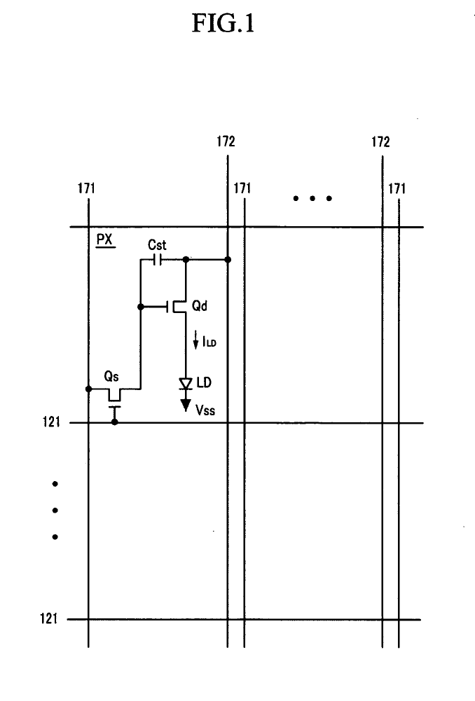

First, an OLED display according to an exemplary embodiment of the present invention will be described in detail with reference to FIG. 1.

FIG. 1 is an equivalent circuit diagram of an OLED display according to an exemplary embodiment of the present invention.

Referring to FIG. 1, the OLED display according to the present exemplary embodiment includes a plurality of signal lines (121, 171, and 172) and a plurality of pixels PX that are connected thereto and arranged in approximately a matrix shape. The signal lines include a plurality of gate lines 121 that transfers gate signals (or scanning signals), a plurality of data lines 171 that transfer data signals, and a plurality of driving voltage lines 172 that transfer a driving voltage. The gate lines 121 extend in a first direction and are substantially parallel to each other, and the data lines 171 and the driving voltage lines 172 extend in approximately a second direction and are substantially parallel to each other. The first direction and the second direction are substantially perpendicular to each other.

Each pixel PX includes a switching transistor Qs, a driving transistor Qd, a storage capacitor Cst, and an OLED LD.

The switching transistor Qs has a control terminal, an input terminal, and an output terminal. The control terminal is connected to the gate line 121, the input terminal is connected to the data line 171, and the output terminal is connected to the driving transistor Qd. The switching transistor Qs transfers a data signal that is applied to the data line 171 to the driving transistor Qd in response to a scanning signal that is applied to the gate line 121.

The driving transistor Qd also has a control terminal, an input terminal and an output terminal. The control terminal is connected to the switching transistor Qs, the input terminal is connected to the driving voltage line 172, and the output terminal is connected to the OLED LD. The driving transistor Qd carries an output current ILD, the magnitude of which changes depending on a voltage that is applied between the control terminal and the output terminal.

The capacitor Cst is connected between the input terminal and the control terminal of the driving transistor Qd. The capacitor Cst is charged with a data signal that is applied to the control terminal of the driving transistor Qd, and maintains the charge even after the switching transistor Qs is turned off.

The OLED LD has an anode that is connected to the output terminal of the driving transistor Qd and a cathode that is connected to a common voltage Vss. The OLED LD emits light by changing the intensity thereof depending on an output current ILD of the driving transistor Qd, whereby an image is displayed. The switching transistor Qs and the driving transistor Qd are n-channel field effect transistors (FETs). However, at least one of the switching transistor Qs and the driving transistor Qd may be a p-channel field effect transistor. Furthermore, the connection relationship of the transistors Qs and Qd, the capacitor Cst, and the OLED LD may be changed.

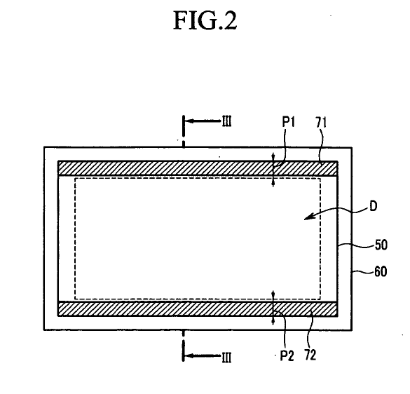

Now, a detailed structure of the OLED display shown in FIG. 1 will be described in detail with reference to FIGS. 2 to 6.

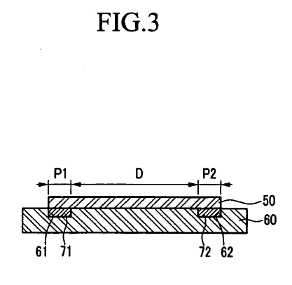

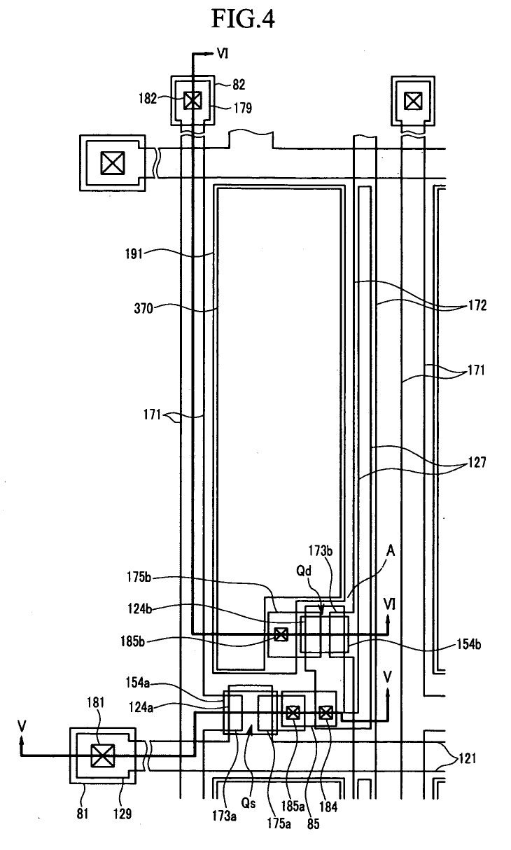

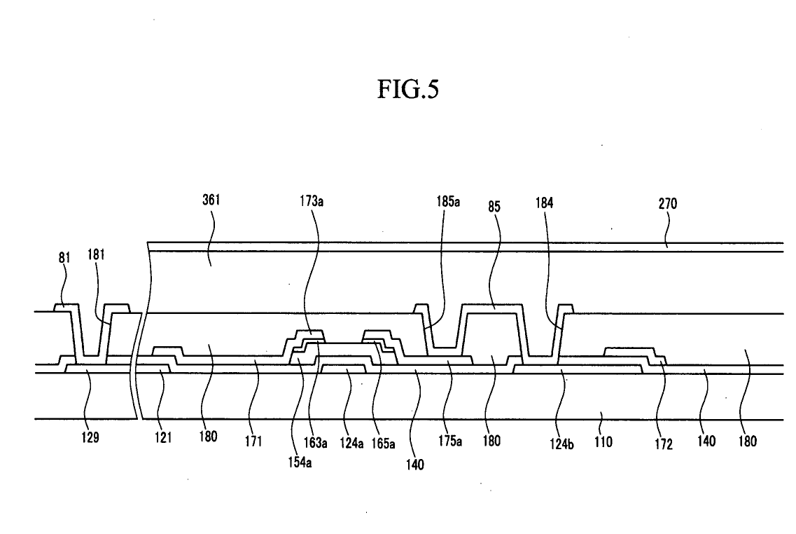

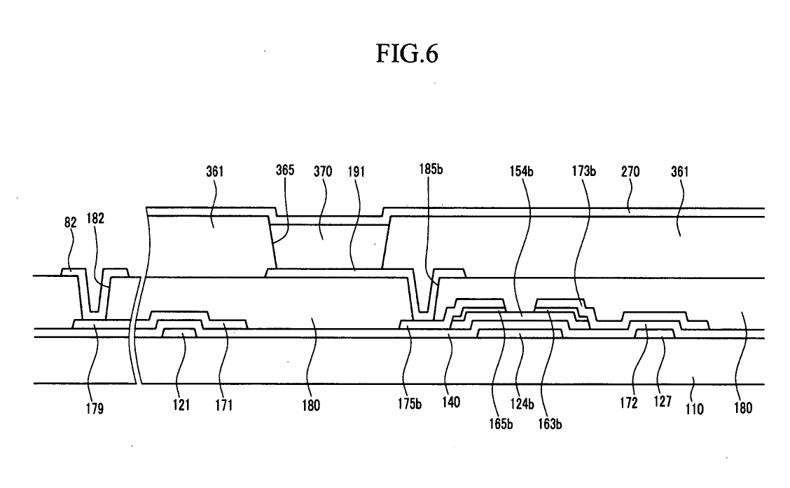

FIG. 2 is a top plan view of an OLED display according to an exemplary embodiment of the present invention, FIG. 3 is a cross-sectional view of the OLED display taken along line II-II of FIG. 2, and FIG. 4 is a layout view of one pixel of an OLED panel of an OLED display according to an exemplary embodiment of the present invention. FIGS. 5 and 6 are cross-sectional views of the OLED display taken along the line V-V and line VI-VI of FIG. 4.

As shown in FIGS. 2 and 3, the OLED display includes an OLED panel 50 that displays an image and that has a plurality of signal lines 121, 171, and 172 and a plurality of pixels, a heat sink 60 that is attached to a lower part of the OLED panel 50, and heat transfer pads 71 and 72 that are positioned between the OLED panel 50 and the heat sink 60.

A specific structure of the OLED panel 50 will be described in detail with reference to FIGS. 4 to 6.

As shown in FIGS. 4 to 6, a plurality of gate lines 121 including first control electrodes 124a and a plurality of gate conductors including second control electrodes 124b are formed on an insulation substrate 110 that is made of transparent glass, plastic, or so on.

Each gate line 121 transfers a gate signal and extends generally in the first direction. Each gate line 121 includes a wide end part 129 for connecting to other layers or an external driving circuit, and a first control electrode 124a that branches out from the gate line 121. When a gate driving circuit (not shown) that generates a gate signal is integrated on the substrate 110, the gate line 121 extends to directly connect to the gate driving circuit.

The second control electrode 124b includes a storage electrode 127 that is separated from the gate line 121 and that extends in a downward direction, then to the right side for a certain distance, and then in the upward direction.

The gate conductors 121 and 124b may be made of an aluminum metal such as aluminum (Al) or an aluminum alloy, a silver metal such as silver (Ag) or a silver alloy, a copper metal such as copper (Cu) or a copper alloy, a molybdenum metal such as molybdenum (Mo) or a molybdenum alloy, chromium (Cr), thallium (Ta), titanium (Ti), and so on. However, they may have a multilayer structure including two conductive layers (not shown) that have different physical properties. Where multiple layers are employed, one conductive layer is made of a metal having low resistivity, such as an aluminum metal, a silver metal, a copper metal, etc., in order to reduce signal delay or voltage drop. The other conductor layer is made of a material that has good physical, chemical, and electrical contact characteristics with other materials, such as a molybdenum metal, chromium (Cr), thallium (Ta), titanium (Ti), etc., particularly ITO (indium tin oxide) and IZO (indium zinc oxide). An example of such a multi-layered structure may include a chromium lower layer and an aluminum (alloy) upper layer, or an aluminum (alloy) lower layer and a molybdenum (alloy) upper layer. However, these are not limitations of the invention and the gate conductors 121 and 124b may be made of other various metals or conductors.

The lateral surfaces of the gate conductors 121 and 124b are inclined relative to a surface of the substrate 110 to form an inclination angle of preferably about 30° to 80°.

A gate insulating layer 140, which is made of silicon nitride SiNx, silicon oxide SiOx, or so on, is formed on the gate conductors 121 and 124b.

A plurality of first and second semiconductor islands 154a and 154b, which are made of hydrogenated amorphous silicon (a-Si), polysilicon, or so on, are formed on the gate insulating layer 140. The first and second semiconductors 154a and 154b are positioned on the first and second control electrodes 124a and 124b, respectively.

A plurality of pairs of first ohmic contacts 163a and 165a and a plurality of pairs of second ohmic contacts 163b and 165b are formed on the first and second semiconductors 154a and 154b, respectively. The ohmic contacts 163a, 163b, 165a, and 165b are formed as electrically isolated islands may be made of a material such as n+ hydrogenated amorphous silicon in which an n-type impurity such as phosphorus is doped with a high concentration, or silcide. The first ohmic contacts 163a and 165a are formed in pairs and disposed on the first semiconductor 154a, and the second ohmic contacts 163b and 165b are formed in pairs and disposed on the second semiconductor 154b.

A plurality of data conductors including a plurality of data lines 171, a plurality of driving voltage lines 172, and a plurality of first and second output electrodes 175a and 175b are formed on the ohmic contacts 163a, 163b, 165a, and 165b and the gate insulating layer 140.

Each data line 171 transfers a data signal and extends generally in a second direction perpendicularly to the gate line 121. Each data line 171 includes a wide end part 179 for connecting a plurality of the first input electrodes 173a that extend toward the first control electrode 124a to other layers or an external driving circuit. When a data driving circuit (not shown) that generates a data signal is integrated on the substrate 110, the data line 171 extends to directly connect to a data driving circuit.

Each driving voltage line 172 transfers a driving voltage and extends generally in the second direction to intersect the gate line 121. Each driving voltage line 172 includes a plurality of second input electrodes 173b that extend toward the second control electrode 124b. The driving voltage line 172 overlaps the storage electrode 127, and they may be connected to each other.

The first and second output electrodes 175a and 175b are separated from each other and are separated from the data line 171 and the driving voltage line 172. The first input electrode 173a and the first output electrode 175a are across the first control electrode 124a from each other, and the second input electrode 173b and the second output electrode 175b are across the second control electrode 124b from each other.

It is preferable that the data conductors 171, 172, 175a, and 175b are made of a refractory metal such as molybdenum, chromium, thallium, and titanium, or their alloys. They may have a multi-layered structure including a refractory metal layer (not shown) and a low resistance conductive layer (not shown). Examples of the multi-layered structure include a dual layer of a chromium or molybdenum (alloy) lower layer and an aluminum (alloy) upper layer, or a triple layer of a molybdenum (alloy) lower layer, an aluminum (alloy) intermediate layer, and a molybdenum (alloy) upper layer. However, these materials are not limitations of the invention and the data conductors 171, 172, 175a, and 175b may be made of other various metals or conductors.

Similarly to the gate conductors 121 and 124b, the lateral surfaces of the data conductors 171, 172, 175a, and 175b are also inclined relative to a surface of the substrate 110 to form an inclination angle of preferably 30° to 80°.

The ohmic contacts 163a, and 165a are formed between the semiconductor 154a and data conductors 173a, 175a. Likewise, the ohmic contacts 163b and 165b are formed between the semiconductor 154b and the data conductors 173b and 175b to reduce contact resistance. The semiconductors 154a and 154b each has a portion that is not covered with the data conductors 171, 172, 175a, and 175b and a portion between the input electrodes 173a and 173b and the output electrodes 175a and 175b.

A passivation layer 180 is formed on the data conductors 171, 172, 175a, and 175b and the exposed portions of the semiconductors 154a and 154b. The passivation layer 180 is made of an inorganic insulator such as silicon nitride (SiNx) or silicon oxide (SiOx), an organic insulator, a low dielectric constant insulator, or so on. The organic insulator and the low dielectric constant insulator preferably have a dielectric constant of 4.0 or less and include, for example, a-Si:C:O and a-Si:O:F that are formed with plasma enhanced chemical vapor deposition (PECVD). In some embodiments, the passivation layer 180 may be made of an organic insulator with photosensitivity among organic insulators, and a surface thereof may be flat. However, the passivation layer 180 may have a dual-layer structure of a lower inorganic layer and an upper organic layer so as not to damage the portion of the semiconductors 154a and 154b that is not covered while benefiting from the strong insulating characteristics of the organic layer.

A plurality of contact holes 182, 185a, and 185b for exposing each of the end parts 179 of the data lines 171 and the first and second output electrodes 175a and 175b are formed in the passivation layer 180. A plurality of contact holes 181 and 184 for exposing the end parts 129 of the gate lines 121 and the second input electrodes 124b are formed in the passivation layer 180 and the gate insulating layer 140.

A plurality of pixel electrodes 191, a plurality of connecting members 85, and a plurality of contact assistants 81 and 82 are formed on the passivation layer 180. They may be made of a transparent conductive material such as ITO or IZO, or a reflective metal such as aluminum, silver, or their alloys.

Each pixel electrode 191 is physically and electrically connected to the second output electrode 175b through the contact hole 185b and the connecting member 85 is connected to the second control electrode 124b and the first output electrode 175a through the contact holes 184 and 185a.

The contact assistants 81 and 82 are connected to an end part 129 of the gate line 121 and an end part 179 of the data line 171 through the contact holes 181 and 182, respectively. The contact assistant 81 supplements the adhesion between the end part 129 of the gate line 121 and an external apparatus, and protect the end part 129. Similarly, the contact assistant 82 helps the adhesion between the end part 179 of the data line 171 and an external apparatus, while also protecting the end part 179.

A partition 361 is formed on the passivation layer 180. The partition 361 defines an opening 365 by surrounding the edge of the pixel electrode 191 like a bank, and is made of an organic insulator or an inorganic insulator. The partition 361 may also be made of a photoresist including a black pigment, and in this case the partition 361 serves as a light blocking member. The partition 361 is formed through a simple process.

An organic light emitting member 370 is formed within the opening 365 on the pixel electrode 191 that is defined by the partition 361. The organic light emitting member 370 is made of an organic material that inherently emits any one of three primary colors (e.g., red, green, and blue). The OLED display displays a desired image with the spatial sum of primary colored lights emitted by the organic light emitting members 370.

The organic light emitting member 370 may have a multi-layered structure including an emission layer (not shown) for emitting light and an auxiliary layer (not shown) for improving light emitting efficiency of the emitting layer. The auxiliary layer includes an electron transport layer (not shown) and a hole transport layer (not shown) for adjusting the balance of electrons and holes, and an electron injecting layer (not shown) and a hole injecting layer (not shown) for enhancing the injection of electrons and holes.

A common electrode 270 is formed on the organic light emitting member 370. The common electrode 270 receives a common voltage Vss, and is made of a reflective metal such as calcium (Ca), barium (Ba), magnesium (Mg), aluminum (Al), silver (Ag), etc., or a transparent conductive material such as ITO, IZO, or so on.

In the OLED display, a first control electrode 124a that is connected to the gate line 121, a first input electrode 173a and a first output electrode 175a that are connected to the data line 171, and a first semiconductor 154a constitute a switching TFT Qs, and a channel of the switching TFT Qs is formed in the first semiconductor 154a between the first input electrode 173a and the first output electrode 175a. A second control electrode 124b that is connected to the first output electrode 175a, a second input electrode 173b that is connected to the driving voltage line 172, a second output electrode 175b that is connected to the pixel electrode 191, and a second semiconductor 154b constitute a driving TFT Qd, and a channel of the driving TFQd is formed in the second semiconductor 154b between the second input electrode 173b and the second output electrode 175b. The pixel electrode 191, the organic light emitting member 370, and the common electrode 270 constitute an OLED LD, and the pixel electrode 191 may become an anode and the common electrode 270 may become a cathode. Depending on the embodiment, the pixel electrode 191 may become a cathode and the common electrode 270 may become an anode. The storage electrode 127 and the driving voltage line 172 that overlap each other constitute a storage capacitor Cst.

The OLED display sends light upward or downward to display an image. The opaque pixel electrode 191 and the transparent common electrode 270 are applied to a top-emission type OLED display in which light is generally directed away from the substrate 110, and the transparent pixel electrode 191 and the opaque common electrode 270 are applied to a bottom-emission type OLED display in which light is generally directed toward the substrate 110 so that an image is viewed from the other side of the substrate 110.

On the other hand, where the semiconductors 154a and 154b are made of polysilicon, they include an intrinsic region (not shown) that is opposite to the control electrodes 124a and 124b and an extrinsic region (not shown) flanking the intrinsic region. The extrinsic region is electrically connected to the input electrodes 173a and 173b and the output electrodes 175a and 175b, and the ohmic contacts 163a, 163b, 165a, and 165b may be omitted.

Furthermore, the control electrodes 124a and 124b may be positioned on the semiconductors 154a and 154b, and if so, the gate insulating layer 140 is positioned between the semiconductors 154a and 154b and the control electrodes 124a and 124b. The data conductors 171, 172, 173b, and 175b may be positioned on the gate insulating layer 140 and be electrically connected to the semiconductors 154a and 154b through a contact hole (not shown) that is formed in the gate insulating layer 140. Alternatively, the data conductors 171, 172, 173b, and 175b are positioned under the semiconductors 154a and 154b to electrically contact the semiconductors 154a, 154b.

The OLED panel 50 is formed with the gate lines 121, the data lines 171, and the pixel electrodes 190, etc., and is divided into an image display unit D that displays an image and peripheral units P1 and P2 that are positioned at the outside thereof and that physically and electrically connect a signal line (not shown) within the image display unit to an FPC substrate (not shown) or a driver IC (not shown).

Particularly, a voltage driver (not shown) is formed in upper and lower peripheral units P1 and P2, and thus significant heat is generated in these regions. Therefore, the upper and lower peripheral units P1 and P2 correspond to the heat generating units of the OLED panel 50.

The heat sink 60 is formed in a rectangular shape like the OLED panel 50 but is preferably larger than the OLED panel 50. It is preferable that the heat sink 60 is made of a metal having high thermal conductivity, such as aluminum, copper, and silver.

The heat transfer pads 71 and 72 are positioned to correspond to the heat generating units P1 and P2 of the OLED panel 50. The heat transfer pads 71 and 72 are made of graphite and may be formed by stacking graphite into a plurality of layers. As the graphite, SpreaderShield™ heat spreaders that are made by Graffech International Ltd. may be used. The heat transfer pads 71 and 72 perform a function of rapidly transferring and uniformly distributing heat.

The heat transfer pads 71 and 72 are shaped into parallel bars, and the bar-shaped heat transfer pads 71 and 72 are inserted into grooves 61 and 62 that are formed along the long sides of the rectangular heat sink 60. Parts of the heat sink 60 around the grooves 61 and 62 come into direct contact with the OLED panel 50.

Therefore, heat generated by the heat generating units P1 and P2 of the OLED panel 50 is transferred to the heat sink 60 through three surfaces of the heat transfer pads 71 and 72 that are inserted into the grooves 61 and 62 of the heat sink 60. Since three surfaces of the bar-shaped heat transfer pads 71 and 72 come into direct contact with the heat sink 60 and the bar-shaped heat transfer pads 71 and 72 are formed only at positions corresponding to the heat generating units P1 and P2 of the OLED panel 50, the pads efficiently discharge heat to prevent overheating of the OLED panel 50.

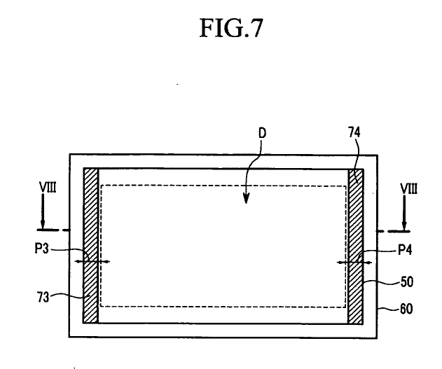

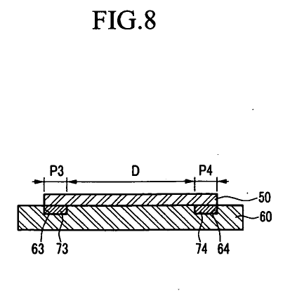

FIG. 7 is a top plan view of an OLED display according to another exemplary embodiment of the present invention, and FIG. 8 is a cross-sectional view of the OLED display taken along the line VIII-VIII of FIG. 7.

As shown in FIGS. 7 and 8, the OLED display according to this exemplary embodiment of the present invention is similar to the OLED display of the previous exemplary embodiment in many ways. However, because a voltage driver is formed at left and right peripheral units P3 and P4 of the OLED display according to this exemplary embodiment of the present invention, excessive heat is generated in these regions. Therefore, the left and right peripheral units P3 and P4 correspond to the heat generating units of the OLED panel 50.

Heat transfer pads 73 and 74 are positioned to contact the heat generating units P3 and P4 of the OLED panel 50.

The heat transfer pads 73 and 74 are shaped into parallel bars, and the bar-shaped heat transfer pads 73 and 74 are inserted into grooves 63 and 64 of the heat sink 60 that are formed along the short sides of the rectangular heat sink 60, respectively. Parts of the heat sink 60 around the grooves 63 and 64 come into direct contact with the OLED panel 50.

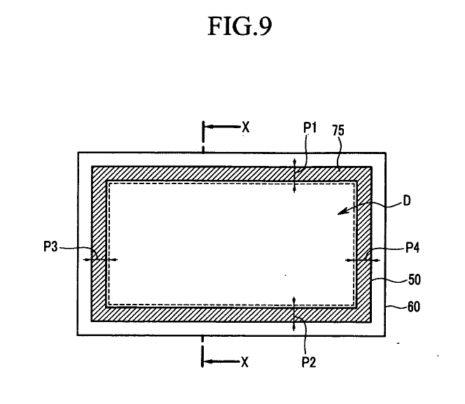

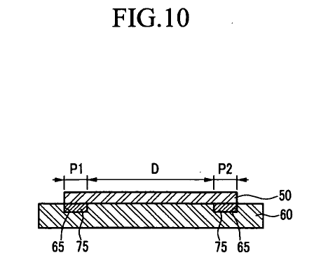

FIG. 9 is a top plan view of an OLED display according to another exemplary embodiment of the present invention, and FIG. 10 is a cross-sectional view of the OLED display taken along the line X-X of FIG. 9.

As shown in FIGS. 9 and 10, an OLED display according to this exemplary embodiment of the present invention is similar to the OLED display according to the previous exemplary embodiments. However, because voltage drivers are formed along all sides of the peripheral units P1, P2, P3, and P4 of the OLED display in this exemplary embodiment, heat is generated from all four sides. Therefore, the peripheral units P1, P2, P3, and P4 correspond to the heat generating units of the OLED panel 50.

A heat transfer pad 75 is positioned to contact the heat generating units P1, P2, P3, and P4 of the OLED panel 50. The heat transfer pad 75 has a rectangular frame shape, and it is inserted into a groove 65 of the heat sink 60. The groove 65 also has a rectangular shape to accommodate the heat transfer pad 75.

Therefore, heat generated by the heat generating units P1, P2, P3, and P4 of the OLED panel 50 is transferred to the heat sink 60 through three surfaces of the heat transfer pad 75 that are inserted into the groove 65 of the heat sink 60. Because three surfaces of the heat transfer pad 75 come into direct contact with the heat sink 60 and the pad is formed in only a position corresponding to the heat generating units P1, P2, P3, and P4 of the OLED panel 50, heat is efficiently discharged to prevent overheating of the OLED panel 50.

According to an OLED display of the present invention, heat is efficiently discharged without making the heat transfer pad unnecessarily large by forming the heat transfer pad to match the areas where heat is generated in an OLED panel.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An organic light emitting display (OLED) comprising:
an OLED panel that displays an image, the OLED panel having a heat generating unit;
a heat sink that is attached to the OLED panel; and
a heat transfer pad that is positioned between the heat sink and the OLED panel, wherein the heat transfer pad is shaped to cover a position of the heat generating unit.

2. The organic light emitting display of claim 1, wherein the OLED panel comprises an image display unit for displaying an image and a peripheral unit adjacent to the display unit, and the heat generating unit of the OLED panel is positioned in the peripheral unit.

3. The organic light emitting display of claim 2, wherein the OLED panel has a rectangular shape and the heat transfer pad is shaped to cover at least one side of the rectangular OLED panel.

4. The organic light emitting display of claim 3, wherein a groove is formed along at least one side of the heat sink to receive the heat transfer pad.

5. The organic light emitting display of claim 2, wherein the OLED panel has a rectangular shape and the heat transfer pad is shaped to cover two parallel sides of the OLED panel.

6. The organic light emitting display of claim 5, wherein a groove is formed along two parallel sides of the heat sink.

7. The organic light emitting display of claim 3, wherein the heat transfer pad is bar-shaped.

8. The organic light emitting display of claim 3, wherein the heat transfer pad is shaped like a frame that substantially matches the outline of the OLED panel.

9. The organic light emitting display of any one of claim 4, wherein the heat transfer pad is inserted into the groove of the heat sink.

10. The organic light emitting display of any one of claims 4, wherein portions of the heat sink around the groove contact the OLED panel.

11. The organic light emitting display of claim 2, wherein a power supply unit of the OLED panel is formed in a peripheral unit of the OLED panel.

12. The organic light emitting display of claim 11, wherein the heat transfer pad is positioned to correspond to the power supply unit of the OLED panel.

13. The organic light emitting display of claim 1, wherein the heat transfer pad comprises a material having high thermal conductivity.

14. The organic light emitting display of claim 13, wherein the heat transfer pad comprises graphite.

15. An organic light emitting display comprising:
an OLED panel that comprises an image display unit for displaying an image and a peripheral unit adjacent to the display unit;
a heat sink that is attached to the OLED panel; and
a heat transfer pad that is positioned between the heat sink and the OLED panel, wherein a power supply unit of the OLED panel is formed in the peripheral unit of the OLED panel, and the heat transfer pad is positioned to correspond to the power supply unit of the OLED panel.

16. An organic light emitting display comprising:
an OLED panel that displays an image;
a heat sink that is attached to the OLED panel; and
a heat transfer pad that is positioned between the heat sink and the OLED panel, wherein the heat transfer pad extends into a groove in the heat sink.

17. An organic light emitting display comprising:
an OLED panel that displays an image;
a heat sink that is attached to the OLED panel; and
a heat transfer pad that is positioned between the heat sink and the OLED panel, wherein a groove is formed in a peripheral unit of the heat sink and the heat transfer pad is inserted into the groove.

18. An organic light emitting display comprising:
an OLED panel that displays an image;
a heat sink that is attached to the OLED panel; and
a heat transfer pad that is positioned between the heat sink and the OLED panel, wherein a part of the heat sink contacts the OLED panel.

19. The organic light emitting display of claim 18, wherein the part of the heat sink contacting the OLED panel is a central part of the heat sink.
